(19) United States
(12) Patent Application Publication
(10) Pub. No.: US 2010/0070471 A1
(43) Pub. Date: Mar. 18, 2010

(54) TRANSACTIONAL APPLICATION EVENTS

(75) Inventor: Himanshu Yadava, Newark, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: ROHATI SYSTEMS, INC., Sunnyvale, CA (US)

(21) Appl. No.: 12/212,441

(22) Filed: Sep. 17, 2008

(51) Int. Cl. G06F 17/30

(52) U.S. Cl. 707/615; 707/E17.005

(57) ABSTRACT

Techniques for processing transactional application events are described herein. In one embodiment, a database transaction record is retrieved from a database transaction log, where the database transaction record includes information of a database transaction and an application event associated with the database transaction. In response, a database operation specified in the database transaction is performed, where the database operation is configured to update one or more records of a database. The application event is extracted from the database transaction record retrieved from the database transaction log. An event operation associated with the application event that is associated with the database transaction is performed, such that when the event operation is performed, the updated one or more records of the database are readily available. Other methods and apparatuses are also described.

### FIELD OF THE INVENTION

The present invention relates generally to application events in a networking environment. More particularly, this invention relates to processing transactional application events.

### BACKGROUND

Every enterprise has a need to secure resources accessed by employees, partners, and customers. For example, browser based access to portals which aggregate resources (web pages, applications, services, etc.) are typical in today's enterprises. Clients send requests to servers for resources, but before a server can return that resource it must determine if the requester is authorized to use the resource. This is also referred to as access control, which is typically performed based on a set of policies to determine whether a client is eligible to access the requested resource. Typically, such configuration information is stored in one or more databases.

Distributed systems that use databases for storing configuration and other information typically have to deal with an inherent race condition. Instead of polling a database for updates, the distributed components are typically designed to listen for update notifications, so that frequent database lookups can be avoided. To increase fault tolerance and scalability, databases are usually replicated to multiple locations within a distributed system.

Since data replication and event notification are two independent activities, race conditions exist. For example, if the data replication of a database update happens after the event notification associated with the update is delivered; a distributed component can end up in a situation where it is not able to find the relevant or updated information in the database even though it is actually present in the database.

### SUMMARY OF THE DESCRIPTION

Techniques for processing transactional application events are described herein. In one embodiment, a database transaction record is retrieved from a database transaction log, where the database transaction record includes information of a database transaction and an application event associated with the database transaction. In response, a database operation specified in the database transaction is performed, where the database operation is configured to update one or more records of a database. The application event is extracted from the database transaction record retrieved from the database transaction log. An event operation associated with the application event that is associated with the database transaction is performed, such that when the event operation is performed, the updated one or more records of the database are readily available.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 is a block diagram illustrating an example of a network configuration according to one embodiment of the invention.

FIGS. 2A and 2B are block diagrams illustrating an example of an application service appliance or gateway according to certain embodiments.

FIGS. 3A-3B are block diagrams illustrating an example of a database transactional system in accordance with certain embodiments of the invention.

FIG. 4 is a block diagram illustrating a system for transactional application events according to one embodiment of the invention.

FIG. 5 is a block diagram illustrating an example of a database transaction log according to one embodiment of the invention.

FIGS. 6A-6B are pseudo codes illustrating a process for handling transactional events according to certain embodiments of the invention.

FIGS. 7 and 8 are flow diagrams illustrating a process for handling transactional events according to certain embodiments of the invention.

### DETAILED DESCRIPTION

Techniques for processing transactional application events are described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

An embodiment of the invention ties event notification with a database update with the actual update and thereby it avoids a race condition set forth above. With embodiments of the present application, application level events can be associated with transactional database updates so that the application level event and the associated database update can be viewed as an atomic operation. One benefit of this technique is that it eliminates most or all the race conditions associated with un-ordered delivery of database updates and the associated application level events. Another advantage of this approach is that messages describing application level state changes can be handled by a single entity on a node, instead of each application having to send and receive update messages.

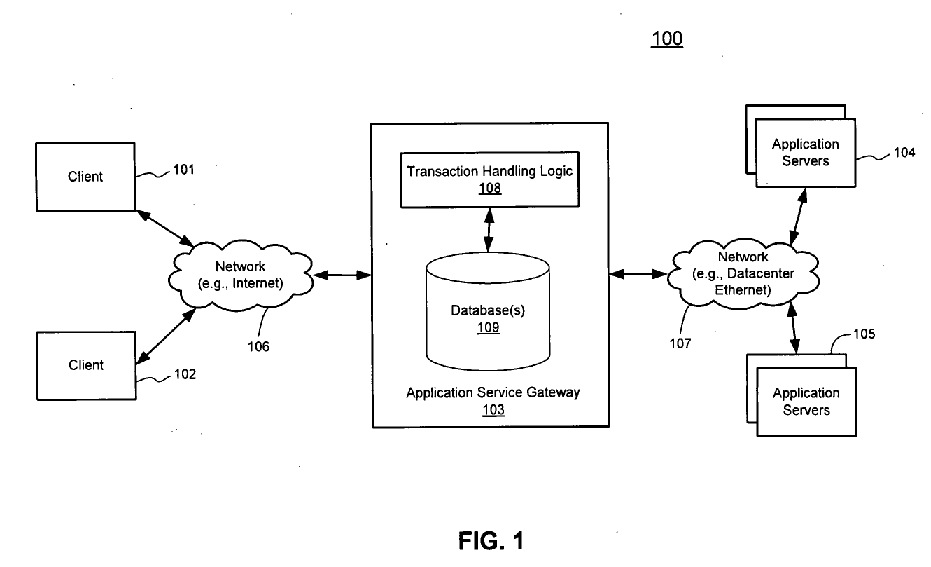

FIG. 1 is a block diagram illustrating an example of a network configuration according to one embodiment of the invention. Referring to FIG. 1, network configuration 100 includes one or more clients 101-102 communicatively coupled to an application service gateway or appliance device 103 in order to access one or more application servers 104-105 of a datacenter over networks 106-107. In order to access applications hosted by application servers 104-105, each of the clients 101-102 has to go through application service appliance 103 over networks 106-107. Network 106 may be a local area network (LAN) or a wide area network (WAN). Alternatively, network 106 may be an internal network of an entity such as intranet. Network 107 may be a converged fabric network such as a datacenter Ethernet (DCE) or InfiniBand™ network.

According to one embodiment, device 103 is configured to perform attribute based authentication and/or authorization of clients 101-102 to determine whether a particular client is eligible to access application servers 104-105. In one embodiment, device 103 includes multiple processors or core logic (not shown) which can be used to process network packets in various ways based on one or more policies. Processors/core logic may be configured to process any of layer 2 to layer 7 of OSI (open system interconnection) network layers of processes. For example, one processor/core may be configured to process layer 2 to layer 5 while another processor/core may be configure to process layer 5 to layer 7, etc. In one embodiment processors/core logic may be implemented using an Octeon™ compatible processor available from Cavium Networks of Mountain View, Calif.

In one embodiment, application service appliance 103 includes certain software components that are running within one or more of the multiple processors/core logic, including a transaction handling logic 108 that is configured to handle transactions of database 109. In one embodiment, an application event is associated with a database transaction or database update which is specified in a transaction record of a database transaction log (not shown). When a particular database transaction is processed by the transaction handling logic 108, in addition to operations associated with the particular database transaction, logic 108 performs additional operations associated with the application event. For example, if a particular database transaction is to update a particular database entry in database 109, after the update has been performed, logic 108 sends a notification to a recipient as part of an application event that has been associated with the database update transaction. As a result, when the recipient receives the notification event, the database has already been updated and the recipient can utility the latest and updated content of the database 109. Thus, typical race conditions can be reduced or eliminated.

Note that network configuration 100 is shown for illustration purposes only. For example, networks 106-107 may be the same network or different networks. Logic as shown may be implemented in software, hardware, or a combination of both. Other configurations may exist.

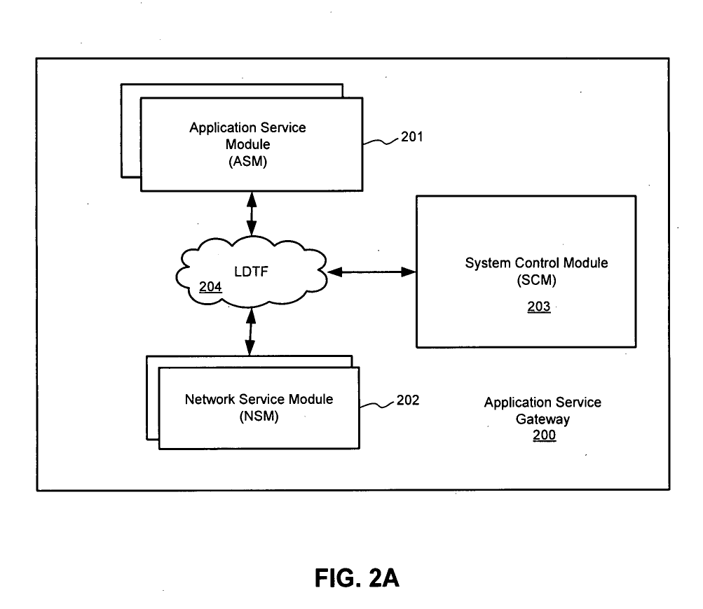

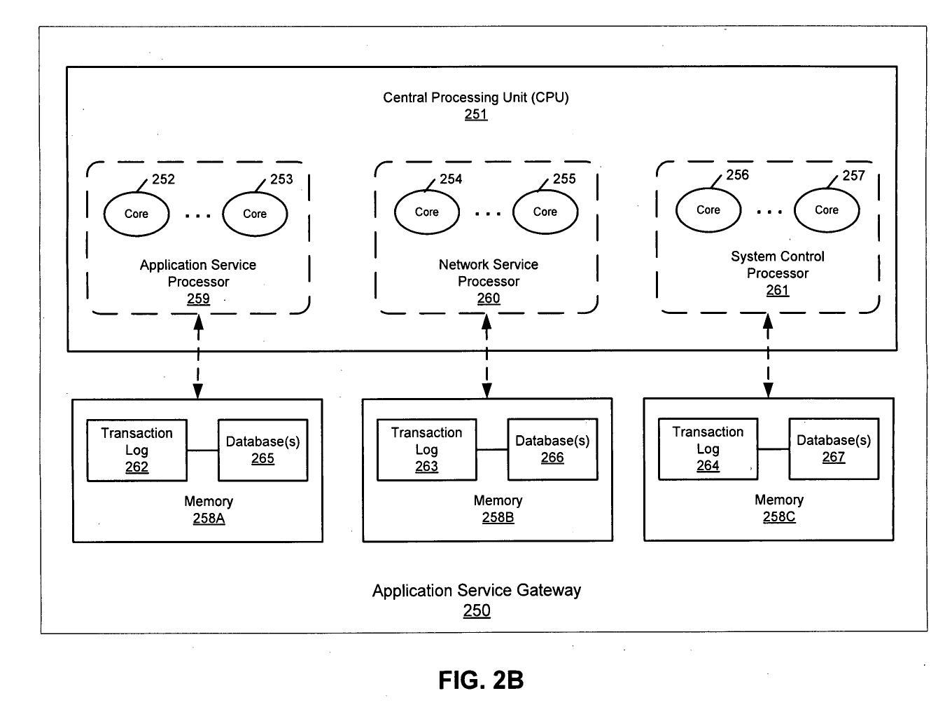

FIG. 2A is a block diagram illustrating an example of an application service appliance or gateway according to one embodiment. For example, device 200 may be implemented as part of application service appliance 103 of FIG. 1. Referring to FIG. 2A, application service appliance 200 includes, but is not limited to, one or more application service modules (ASMs) 201 (also referred to as an application service plane) communicatively coupled to one or more network service modules (NSMs) 202 (also referred to as a network service plane) over a lossless switch fabric 204 (also referred to as a lossless data transport fabric or LDTF), which may be an InfiniBand™ compatible switch fabric. In addition, application service appliance 200 includes a system control module (SCM) 203 (also referred to as a management plane) coupled to the LDTF 204 for managing the ASMs 201 and NSMs 202.

ASMs 201 are configured to perform layer 4 to layer 7 access control based on attribute-based policies, including performing triangulated authorization based on various attributes, including user attributes, network attributes, environment attributes, and/or resource attributes, etc. An NSM includes one or more network service processor (NSP) and an ASM includes one or more application service processors (ASP).

According to one embodiment, application service appliance 200 is essentially a high-speed full-proxy device and it needs to terminate both client and server ends of a client to server connection. In effect application service appliance 200 acts as a virtual server to actual clients (e.g., clients 101-102 of FIG. 1), and a virtual client to actual servers (e.g., servers 104-105 of FIG. 1). Also, application service appliance 200 is configured to scale in order to be able to process a significant portion of the traffic passing through. This highly-scalable L7 processing bandwidth is a unique differentiator for application service appliance 200, as opposed to existing L4-L7 devices, as they expect the bulk of the traffic processing through the device to be unexamined and unchanged, hence can use a high-speed flow-switching fast path to achieve the target throughput.

According to one embodiment, SCM 203 is responsible for common system management functions as well as configuration and management of processing elements in network and application plane. The SCM 203 includes a low-end processor (also referred to as a management service processor) and has an additional out-of-band connectivity to processing elements on ASMs 201 and NSMs 202. Typically, image download, configuration information, statistic collection messages are exchanged between SCM 203 and rest of the system.

In one embodiment, NSM 202 is responsible for ingress and egress processing of external data path, IP stack for virtual interface, TCP and SSL termination, fast path flow switching, byte stream load balancing among multiple ASMs, and stream replication to a backup NSM, etc. ASM 201 is responsible for protocol proxy such as HTTP, CIFS, JDBC, etc. ASM 201 may include a protocol recognition engine, regular expression engine, rule engine, and application authorization engine, etc.

The software architecture of application service appliance 200 employs the combination of both these approaches for providing a layer 7 service. For example, TCP/SSL function is performed on one set of cores and then application processing is performed on another set of cores. Cores running application are equally capable and any available core can be used for application processing.

According to certain embodiments of the invention, SCM 203 may include a database having a master copy of data stored therein. When an application (not shown) needs to update certain records of the database, an application event associated with the corresponding database transaction is inserted as a record into a database transaction log. When the data of the database and the transaction log is replicated, for example, to ASM 201 and/or NSM 202, transaction logic within the ASM 201 and/or NSM 202 processes the database transaction according to the records listed in the database transaction log. For each record of the transaction log, after the database transaction has been completed, the associated application event is triggered. For example, the application event may be a notification event that notifies a recipient with respect to update of the database.

Note that ASMs 201 and NSMs 202 may be implemented as part of multiple processors, where each processor may include multiple cores or alternatively, ASMs 201 and NSMs 202 may be implemented as part of a single processor having multiple cores communicatively coupled to each other via an interconnect or bus, or a shared memory.

FIG. 2B is a block diagram illustrating an example of an application service appliance or gateway according to an alternative embodiment. Referring to FIG. 2B, in this example, application service gateway or appliance 250 is implemented using a single processor 251 having multiple cores 252-257 (e.g., 16 cores). Certain portions of cores 252-257 may be logically configured or partitioned to be designated as an application service processor (ASP) as part of an ASM, a network service processor (NSP) as part of an NSM, or a system control processor (SCP) as part of an SCM described above.

In this example, as shown in FIG. 2B, cores 252-253 are logically configured as an ASP 259; cores 254-255 are logically configured as an NSP 260; and cores 256-257 are logically configured as an SCP 261. The functionalities of ASP 259, NSP 260, and SCP 261 are similar to those as shown in FIG. 2A. For example, ASP 259 may be configured to handle layer 5 to layer 7 processes while NSP 260 may be configured to handle layer 2 to layer 5 processes. Note that although a single ASP, NSP and SCP are shown; multiple ASPs, NSPs, and SCPs may also be implemented, dependent upon a specification design.

In one embodiment, ASP 259, NSP 260, and SCP 261 communicate with each other via a bus or an interconnect, as well as via a shared memory, which may be implemented internally, externally, or a combination of both internal and external memories with respect to CPU 251. In addition, each of the processors 259-261 is communicatively coupled to an associated memory (e.g., memories 258A-258C) for storing a transaction log and its associated database or databases. In this example, processors 259-261 are associated with transaction logs 262-264 and database 265-267 respectively. At least one record of a transaction log includes an application event associated with the respective record, which may be launched during or after the respective transaction record processed. For example, transaction log 266 and database 267 may be a master copy while transaction logs 262-263 and databases 265-266 may be slave copies replicated from the master copy. Note that memories 258A-258C may be implemented as separate memories or alternatively, they may be implemented as a separate memory regions of the same physical memory. Other configurations may exist.

Transactional databases usually maintain a transaction log. A transaction log is a record of the modifications performed on the database. The transaction log is typically used for replication, in addition to other things. The technique described in this document uses the transaction log to create the association between the database update and the application level event that caused the update.

The association of the application level event with the database update is achieved by inserting enough information about the sender, the receiver and the application event, that is needed to deliver the event on the remote node, in the associated database transaction.

Database replication is used in most distributed environments to make the data available on numerous processing nodes in order to provide load balancing and fault tolerance. The most common data replication approach involves replicating the transaction log to the replicas. When transaction logs, containing information about the application level events, are replicated to the replicas the applications events also get replicated.

When a transaction is applied on a replica the database component running on the replica sends the application events embedded in the transaction log to the relevant end points on the node. When the application event is received by the receiver the data associated with the event is guaranteed to be found in the local copy of the database.

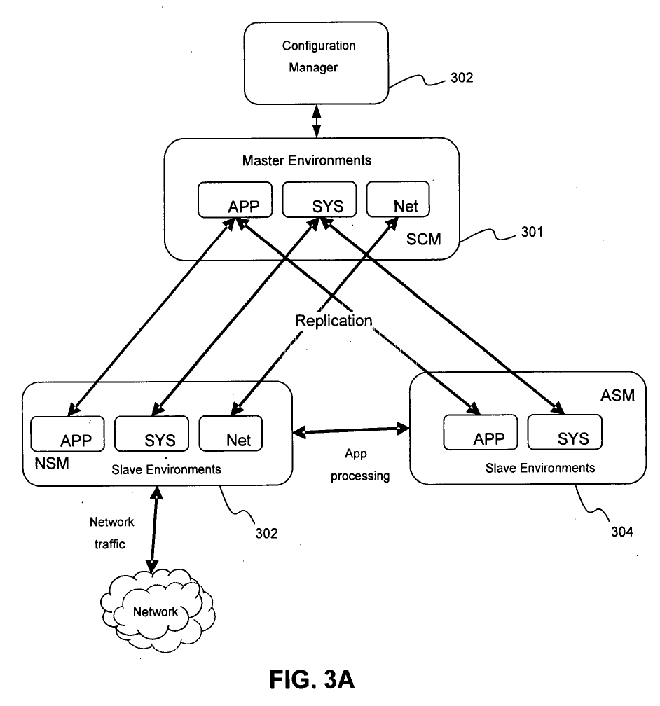

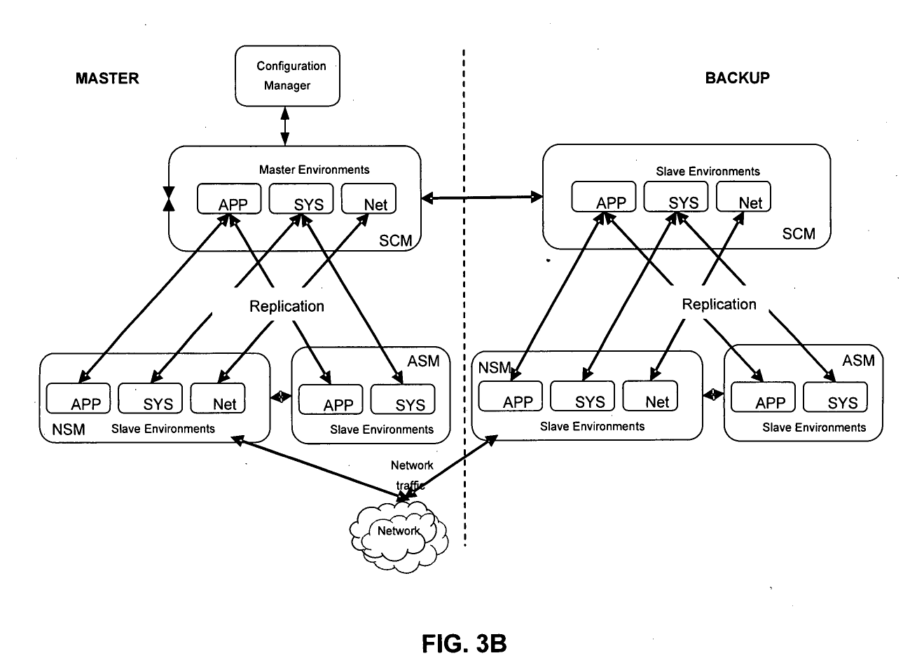

FIGS. 3A-3B are block diagrams illustrating an example of a database transactional system in accordance with certain embodiments of the invention. For examples, systems as shown in FIGS. 3A-3B may be implemented as part of systems as shown in FIGS. 1 and 2A-2B described above. Referring to FIG. 3A, in this example, database transactions such as database replication are performed among different components of a network element. In one embodiment, SCM 301 maintains a master copy of a database and application events (e.g., application, system, and/or network data/events) which may be configured by configuration manager 302, while other components such as NSM 303 and/or ASM 304 maintain a slave or replicated copy of the database and/or application events. According to one embodiment, each of the slave components such as NSM 303 and ASM 304 includes a replication agent responsible for replicating database transactions and application events from SCM 301.

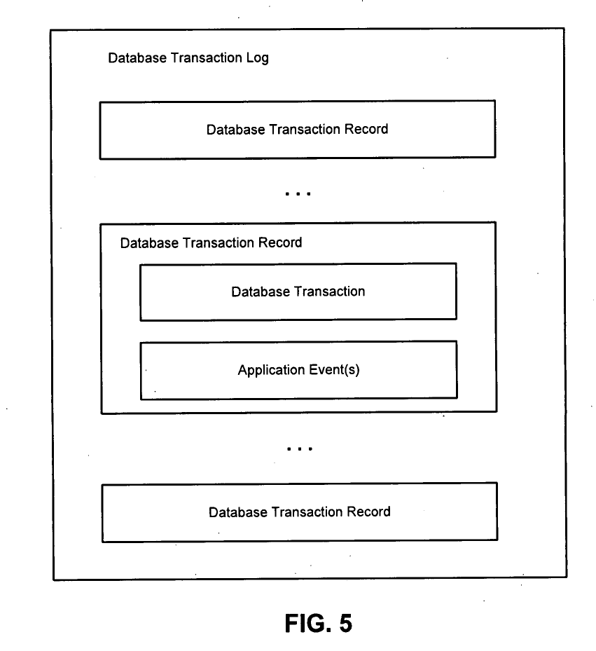

In one embodiment, when an application associated with SCM 301 updates a record of a database (not shown) stored within SCM 301, the application creates a database transaction record and an application event within the transaction record. The transaction record is then inserted into a database transaction log for execution, as shown in FIG. 5. When NSM 303 and/or ASM 304 replicate the database from SCM 301, the database transaction log is also replicated to the NSM 303 and/or ASM 304. When the replication agent within the NSM 303 and/or ASM 304 processes the database transaction log, the replication agent performs any necessary database operation or transaction associated with the database transaction record. In addition, the replication agent processes the application event that is embedded or associated with the database transaction record, such as, for example, sending a notification to a recipient (e.g., application running within NSM 303 and/or ASM 304). As a result, when the recipient receives the notification, the data in the replicated database is readily available and the typical race conditions have been eliminated or reduced.

For example, it is possible (if event notification and data replication are independent functions) that when a configuration manager 302 changes NSM configuration, the event notification for the change arrives on NSM 303 before the database gets replicated. Since database replication usually takes longer than the event notification, this situation can end up in a situation where it is not able to find the relevant information in the database, even when the information is actually present in the database. An embodiment of this application ties the event notification associated with a database update with the actual update and thereby it avoids the race condition described above.

Note that, the techniques described herein are not only applicable to transactions among different components within a network element. Such techniques are also applicable to transactions among different network elements as well as different components within a particular network element, as shown in FIG. 3B. Other configurations may also exist.

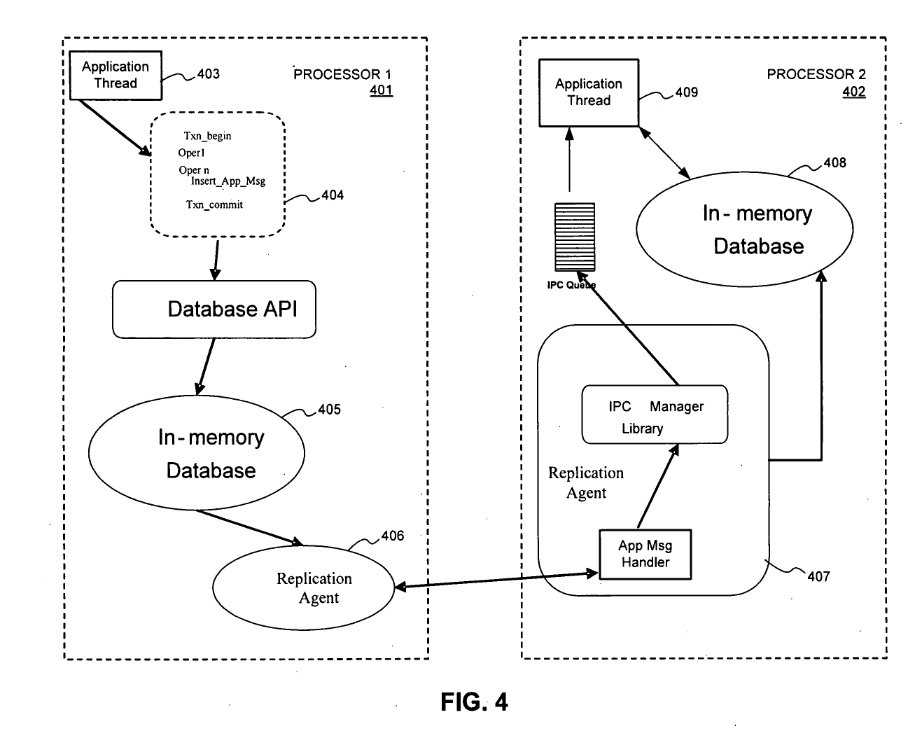

FIG. 4 is a block diagram illustrating a system for transactional application events according to one embodiment of the invention. Referring to FIG. 4, data and application events are replicated from processor 401 to processor 401, which may be two different nodes within a network element or two different nodes over a network.

As described above, transactional databases usually maintain a transaction log. A transaction log is a record of the modifications performed on the database. The transaction log is typically used for replication, in addition to other things. An embodiment of the invention uses the transaction log to create the association between the database update and the application level event that caused the update.

In one embodiment, the association of the application level event with the database update is achieved by inserting (e.g., by configuration manager or via a command line interface or CLI) enough information about the sender, the receiver and the application event, that is needed to deliver the event on the remote node, which may be located within the same network element or a node in another network element. Database replication is used in most distributed environments to make the data available on numerous processing nodes in order to provide load balancing and fault tolerance. The most common data replication approach involves replicating the transaction log to the replicas. When transaction logs, containing information about the application level events are replicated to the replicas the applications events also get replicated. When a transaction is applied on a replica the database component on the node. When the application event is received by the receiver the data associated with the event is guaranteed to be found in the local copy of the database.

For example, as shown in FIG. 4, application thread 403 inserts an application event in a database transaction 404 which is stored in a data transaction log of database 405. In one embodiment, an application event is inserted as an IPC (inter-processor communications) message. The database 405 and the database transaction log are then replicated by replication agent 406 from processor 401 to processor 402. After processor 402 received the replicated data from processor 401, the corresponding replication agent 407 stores the replicate data in the corresponding database 408. In addition, application message handler extracts the embedded application event from the transaction log and perform necessary actions to deliver the application event (e.g., notification event) to a recipient, application thread 409. As a result, when application thread 409 receives the application event, the relevant data has been replicated in database 408. The application message handler is a thread that runs within a replication agent, where it extracts the application events from the transaction log and sends them to the recipients via an IPC library. The IPC Library implements the inter process communication function.

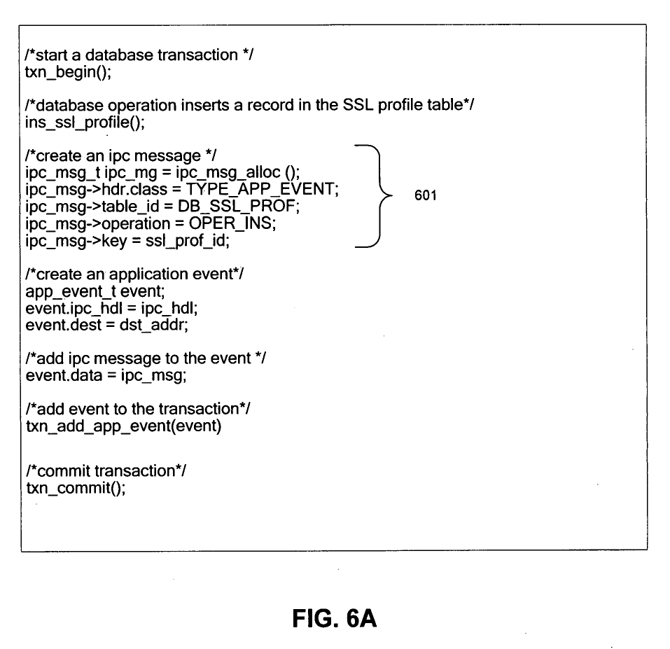

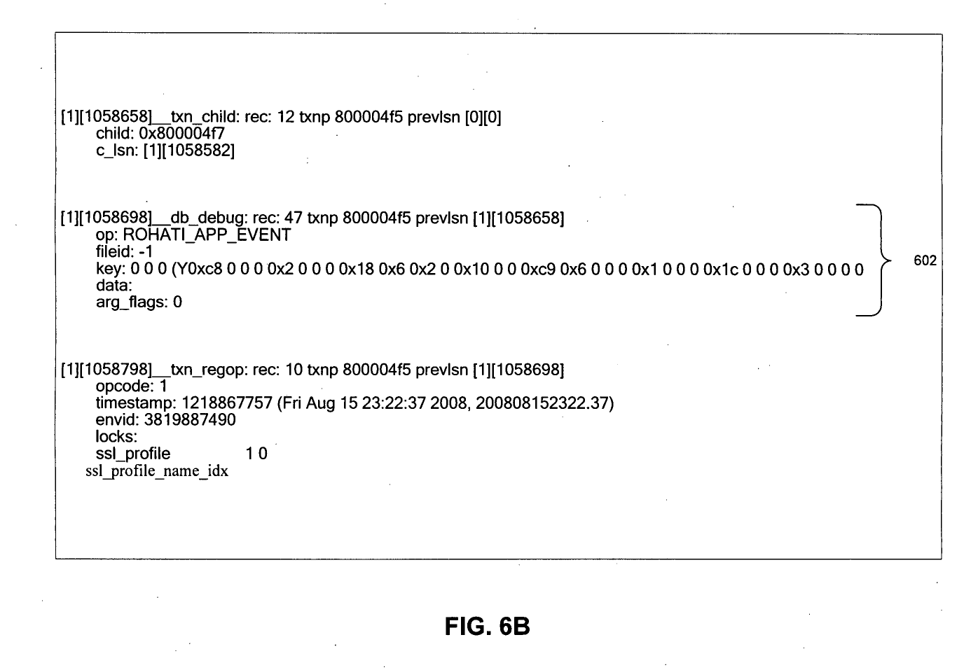

FIG. 6A is pseudo code illustrating insertion of a message 601 containing an application event into a database transaction. FIG. 6B is pseudo code illustrating a database transaction log containing a transaction 602 with an application event embedded therein. The application message handler thread running inside the replication agent processes the inserted event. The “key” field in the transaction log contains the information inserted by a sender in a binary format. The application message handler interprets the binary data, creates the event, and sends it to the receiver. The receiver's information is also contained in the binary field.

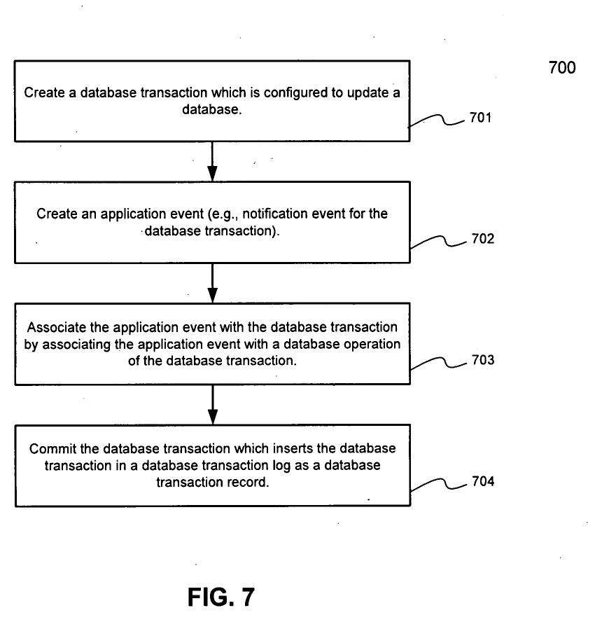

FIG. 7 is a flow diagram illustrating a process for handling transactional application events according to one embodiment of the invention. Note that process 700 may be performed by processing logic which may include software, hardware, or a combination of both. For example, process 700 may performed by systems as shown FIGS. 1 and 2A-2B as described above. Referring to FIG. 7, at block 701, a database transaction is created, which is configured to update one or more records of a database. At block 702, an application event is created. Such an application event may be a notification event for notifying a recipient regarding the database updates in the database transaction. At block 703, the application event is associated with the database transaction. For example, an IPC message having the application event is inserted into the database transaction. At block 704, processing logic commits the database transaction, which inserts the database transaction having the embedded application event into the corresponding database transaction log.

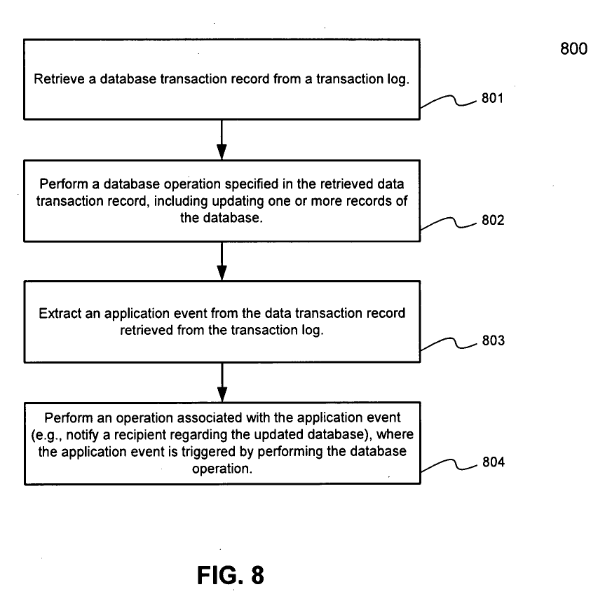

FIG. 8 is a flow diagram illustrating a process for handling transactional application events according to another embodiment of the invention. Note that process 800 may be performed by processing logic which may include software, hardware, or a combination of both. For example, process 800 may performed by systems as shown FIGS. 1 and 2A-2B as described above. Referring to FIG. 8, at block 801, processing logic receives a database transaction from a database transaction log. For example, the database transaction log as well as its associated data is replicated from another node. In response to the database transaction, at block 802, processing logic (e.g., replication agent) performs a database operation associated with the transaction. In addition, at block 803, processing logic extracts an application event from the database transaction. The application event may be inserted by a remote node (e.g., sender) to be associated with the database transaction. At block 804, processing logic performs an operation associated with the extracted application event, such as, for example, sending a notification to a recipient regarding the database operation associated with the transaction. In one embodiment, the application event is triggered by performing the database operation associated with the transaction. Other operations may also be performed.

Thus, techniques for processing transactional application events have been described herein. Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein. In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method performed by a network element, the method comprising:
receiving a database transaction record retrieved from a database transaction log, the database transaction record including information of a database transaction and an application event associated with the database transaction;
performing a database operation specified in the database transaction, wherein the database operation is configured to update one or more records of a database;
extracting the application event from the database transaction record retrieved from the database transaction log; and
performing an event operation associated with the application event that is associated with the database transaction, such that when the event operation is performed, the updated one or more records of the database are readily available.

2. The method of claim 1, wherein the database transaction log is replicated from a remote node, and wherein the remote node inserts the application event into the database transaction record which is stored in the database transaction log.

3. The method of claim 2, wherein the remote node is one of a node within the network element and a node in another network element communicatively coupled to the network element over a network.

4. The method of claim 1, wherein performing an event operation comprises transmitting a notification event to a recipient in response to the application event, such that when the recipient receives the notification event, the updated one or more records of the database are readily available.

5. The method of claim 4, wherein the notification event is triggered in response to updating the one or more records of the database as part of processing the database transaction record retrieved from the database transaction log.

6. The method of claim 5, wherein the application event is embedded within an IPC (inter-process communications) message inserted into the database transaction record of the database transaction log.

7. The method of claim 6, wherein performing an event operation comprises sending the IPC message to the recipient via an IPC communications mechanism in response to the database transaction.

8. The method of claim 1, wherein the network element is an application service gateway to a data center, and wherein in order to reach an application server of the data center, each client has to go through the application service gateway.

9. A machine-readable storage medium having instructions stored therein, which when executed by a processing logic, cause the processing logic to perform a method, the method comprising:
receiving a database transaction record retrieved from a database transaction log, the database transaction record including information of a database transaction and an application event associated with the database transaction;
performing a database operation specified in the database transaction, wherein the database operation is configured to update one or more records of a database;
extracting the application event from the database transaction record retrieved from the database transaction log; and
performing an event operation associated with the application event that is associated with the database transaction, such that when the event operation is performed, the updated one or more records of the database are readily available.

10. The machine-readable storage medium of claim 9, wherein the database transaction log is replicated from a remote node, and wherein the remote node inserts the application event into the database transaction record which is stored in the database transaction log.

11. The machine-readable storage medium of claim 10, wherein the remote node is one of a node within the network element and a node in another network element communicatively coupled to the network element over a network.

12. The machine-readable storage medium of claim 9, wherein performing an event operation comprises transmitting a notification event to a recipient in response to the application event, such that when the recipient receives the notification event, the updated one or more records of the database are readily available.

13. The machine-readable storage medium of claim 12, wherein the notification event is triggered in response to updating the one or more records of the database as part of processing the database transaction record retrieved from the database transaction log.

14. The machine-readable storage medium of claim 13, wherein the application event is embedded within an IPC (inter-process communications) message inserted into the database transaction record of the database transaction log.

15. The machine-readable storage medium of claim 14, wherein performing an event operation comprises sending the IPC message to the recipient via an IPC communications mechanism in response to the database transaction.

16. The machine-readable storage medium of claim 9, wherein the network element is an application service gateway to a data center, and wherein in order to reach an application server of the data center, each client has to go through the application service gateway.

17. A network element, comprising:
a replication agent to receive a database transaction record retrieved from a database transaction log, the database transaction record including information of a database transaction and an application event associated with the database transaction;
a database, wherein the replication agent performs a database operation specified in the database transaction, wherein the database operation is configured to update one or more records of the database;
an application event handler to extract the application event from the database transaction record retrieved from the database transaction log, wherein the application event handler performs an event operation associated with the application event that is associated with the database transaction, such that when the event operation is performed, the updated one or more records of the database are readily available.

18. The network element of claim 17, wherein the database transaction log is replicated from a remote node, and wherein the remote node inserts the application event into the database transaction record which is stored in the database transaction log.

19. The network element of claim 18, wherein the remote node is one of a node within the network element and a node in another network element communicatively coupled to the network element over a network.

20. The network element of claim 17, wherein the network element is an application service gateway to a data center, and wherein in order to reach an application server of the data center, each client has to go through the application service gateway.
